(19) United States
(12) Patent Application Publication
(10) Pub. No.: US 2026/0161575 A1
(43) Pub. Date: Jun. 11, 2026

(54) MEMORY ACCESS CONTROL CIRCUITRY

(71) Applicant: Arm Limited, Cambridge (GB)

(72) Inventors: Sriram Kumar MANOHARAN, Chandler, AZ (US); Kim Richard SCHUTTENBERG, Gilbert, AZ (US); Richard F BRYANT, Chandler, AZ (US)

(21) Appl. No.: 18/973,315

(22) Filed: Dec. 9, 2024

(51) Int. Cl. G06F 13/16; G06F 12/02

(52) U.S. Cl. CPC G06F 13/1631; G06F 12/1458; G06F 12/1483

(57) ABSTRACT

There is provided an apparatus comprising processing circuitry to issue a memory access request specifying a target address. The apparatus comprises memory access control circuitry to control handling of the memory access request based on a memory access control attribute associated with the target address. The memory access control circuitry comprises attribute storage circuitry to store entries each identifying a region of address space and a memory access control attribute. The memory access control circuitry is responsive to the memory access request to perform a lookup in the attribute storage circuitry. The processing circuitry comprises current region identifying information indicative of a current region of address space and a current memory access control attribute. The processing circuitry is configured, when the target address is comprised in the current region, to indicate the current memory access control attribute to the memory access control circuitry, and to omit the lookup.

### TECHNICAL FIELD

The present invention relates to data processing. More particularly the present invention relates to an apparatus, a system, a chip containing product, a method, and a computer-readable medium.

### BACKGROUND

Some apparatuses are provided with memory access control circuitry to control handling of memory access requests. The control may be based on memory access control attributes associated with a region of address space specified in the memory access requests.

### SUMMARY

According to a first aspect of the present techniques there is provided an apparatus comprising:
processing circuitry configured to issue a memory access request specifying a target address; and
memory access control circuitry configured to control handling of the memory access request based on at least one memory access control attribute associated with a corresponding region of address space including the target address, the memory access control circuitry comprising attribute storage circuitry configured to store a plurality of entries, each of the plurality of entries identifying a corresponding region of address space and information indicating at least one corresponding memory access control attribute for the corresponding region of address space,
wherein:
the memory access control circuitry is responsive to receipt of the memory access request to perform an attribute lookup in the attribute storage circuitry for the target address to identify the at least one memory access control attribute associated with the corresponding region of address space comprising the target address;
the processing circuitry comprises current region identifying information indicative of a current region of address space and at least one current memory access control attribute associated with the current region of address space; and
the processing circuitry is configured to determine whether the target address is comprised in the current region of address space and, when the target address is comprised in the current region of address space, to indicate the at least one current memory access control attribute to the memory access control circuitry, and to trigger the memory access control circuitry to omit performing the attribute lookup.

According to a second aspect of the present techniques there is provided a system comprising:
the apparatus according to the first aspect, implemented in at least one packaged chip;
at least one system component; and
a board,
wherein the at least one packaged chip and the at least one system component are assembled on the board.

According to a third aspect of the present techniques there is provided a chip-containing product comprising the system according to the second aspect, wherein the system is assembled on a further board with at least one other product component.

According to a fourth aspect of the present techniques there is provided a method of operating an apparatus comprising processing circuitry and memory access control circuitry, the method comprising:
issuing, by the processing circuitry, a memory access request specifying a target address;
controlling handling of the memory access request based on at least one memory access control attribute associated with a corresponding region of address space including the target address;
storing, in attribute storage circuitry comprised in the memory access control circuitry, a plurality of entries, each of the plurality of entries identifying a corresponding region of address space and information indicating at least one corresponding memory access control attribute for the corresponding region of address space;
in response to receipt, by the memory access control circuitry, of the memory access request to perform an attribute lookup in the attribute storage circuitry for the target address to identify the at least one memory access control attribute associated with the corresponding region of address space comprising the target address,
wherein the processing circuitry comprises current region identifying information indicative of a current region of address space and at least one current memory access control attribute associated with the current region of address space; and
determining, by the processing circuitry, whether the target address is comprised in the current region of address space and, when the target address is comprised in the current region of address space, indicating the at least one current memory access control attribute to the memory access control circuitry, and triggering the memory access control circuitry to omit performing the attribute lookup.

According to a fifth aspect of the present techniques there is provided a non-transitory computer-readable medium storing computer-readable code for fabrication of an apparatus comprising:
processing circuitry configured to issue a memory access request specifying a target address; and
memory access control circuitry configured to control handling of the memory access request based on at least one memory access control attribute associated with a corresponding region of address space including the target address, the memory access control circuitry comprising attribute storage circuitry configured to store a plurality of entries, each of the plurality of entries identifying a corresponding region of address space and information indicating at least one corresponding memory access control attribute for the corresponding region of address space,
wherein:
the memory access control circuitry is responsive to receipt of the memory access request to perform an attribute lookup in the attribute storage circuitry for the target address to identify the at least one memory access control attribute associated with the corresponding region of address space comprising the target address;
the processing circuitry comprises current region identifying information indicative of a current region of address space and at least one current memory access control attribute associated with the current region of address space; and
the processing circuitry is configured to determine whether the target address is comprised in the current region of address space and, when the target address is comprised in the current region of address space, to indicate the at least one current memory access control attribute to the memory access control circuitry, and to trigger the memory access control circuitry to omit performing the attribute lookup.

### BRIEF DESCRIPTION OF THE DRAWINGS

The present invention will be described further, by way of example only, with reference to configurations thereof as illustrated in the accompanying drawings, in which:

FIG. 1 schematically illustrates an apparatus according to some configurations of the present techniques;

FIG. 2 schematically illustrates an apparatus according to some configurations of the present techniques;

FIG. 3 schematically illustrates attributes of memory regions according to some configurations of the present techniques;

FIG. 4 schematically illustrates processing circuitry according to some configurations of the present techniques;

FIG. 5 schematically illustrates memory access control circuitry according to some configurations of the present techniques;

FIG. 6 schematically illustrates an apparatus according to some configurations of the present techniques;

FIG. 7 schematically illustrates an apparatus according to some configurations of the present techniques;

FIG. 8a schematically illustrates an apparatus according to some configurations of the present techniques;

FIG. 8b schematically illustrates an apparatus according to some configurations of the present techniques;

FIG. 9 schematically illustrates memory access control circuitry according to some configurations of the present techniques;

FIG. 10 schematically illustrates processing circuitry according to some configurations of the present techniques;

FIG. 11 schematically illustrates a sequence of steps carried out according to some configurations of the present techniques; and

FIG. 12 schematically illustrates a system and a chip containing product according to some configurations of the present techniques.

### DESCRIPTION OF EXAMPLE CONFIGURATIONS

Before discussing the configurations with reference to the accompanying figures, the following description of configurations is provided.

According to some configurations of the present techniques there is provided an apparatus comprising processing circuitry configured to issue a memory access request specifying a target address. The apparatus also comprises memory access control circuitry configured to control handling of the memory access request based on at least one memory access control attribute associated with a corresponding region of address space including the target address, the memory access control circuitry comprising attribute storage circuitry configured to store a plurality of entries, each of the plurality of entries identifying a corresponding region of address space and information indicating at least one corresponding memory access control attribute for the corresponding region of address space. The memory access control circuitry is responsive to receipt of the memory access request to perform an attribute lookup in the attribute storage circuitry for the target address to identify the at least one memory access control attribute associated with the corresponding region of address space comprising the target address. The processing circuitry comprises current region identifying information indicative of a current region of address space and at least one current memory access control attribute associated with the current region of address space. The processing circuitry is configured to determine whether the target address is comprised in the current region of address space and, when the target address is comprised in the current region of address space, to indicate the at least one current memory access control attribute to the memory access control circuitry, and to trigger the memory access control circuitry to omit performing the attribute lookup.

The apparatus is provided with processing circuitry and memory access control circuitry. The processing circuitry is configured to perform processing operations, for example, in response to instructions included in an instruction set architecture that cause the processing circuitry to operate on data in a defined way. The processing instructions may include a range of different instructions for processing data and for accessing data in memory, e.g. instructions for which a memory access request is issued, fetch requests to fetch instructions and/or prefetch requests for data or instructions. The memory access request specifies a target address indicated a region of memory from which the data (which may include data representative of instructions) is to be retrieved. For example, the memory access requests may be issued by a load/store unit in response to a load/store instruction. In addition, memory access requests may be issued by a fetch unit configured to retrieve instructions to be processed by the processing circuitry. As a further example, the memory access requests may include prefetch requests, issued by one or more instruction prefetchers and/or one or more data prefetchers.

The memory access request is passed from the processing circuitry to the memory access control circuitry which is configured to control how the memory access request is handled. In particular, the memory access control circuitry is configured to determine which of a set of address regions, the target memory address in the memory access request belongs to and to determine one or more memory access control attributes (otherwise referred to herein as attributes) associated with that region of memory address space. For example, the memory access control attributes could specify access permissions which indicate the conditions under which memory accesses are allowed to the corresponding region. For example, the access permissions could restrict access to the region to software executing at a certain privilege level or in a certain mode of operation of the processing circuitry, and/or could restrict the types of accesses allowed. For example, some regions may only be allowed to be accessed for instruction accesses but not data accesses, or vice versa, while other regions may further limit which type of data accesses (reads or writes) are allowed by defining the region as read-only, or both readable and writable. Memory access control attributes can also be defined to control how memory access requests to the region, when permitted, are handled, such as defining whether it is allowable to cache data obtained from memory for the corresponding region, or whether it is permitted to reorder successive memory access requests to be performed in a different order from the order in which they were issued.

In order to reduce the latency associated with determining the memory access control attributes associated with a region of address space, the memory access control circuitry is provided with attribute storage circuitry to store memory access control attributes of a plurality of regions of address space. The attribute storage circuitry can therefore be used to perform a lookup to determine if the target address falls within one of the regions that is stored in the attribute storage circuitry. The provision of the attribute storage circuitry as a dedicated storage structure for the memory control attributes reduces the need for a lookup to be performed in main memory or further non-dedicated storage circuitry that may introduce a longer latency. The inventors have recognised that there are a number of common use cases in which consecutive memory access requests will identify target addresses that fall within the same region of address space and that a further reduction in latency could be achieved by retaining, in the processing circuitry, current region identifying information indicative of a current region of address space and the at least one current memory access control attribute associated with the current region of address space.

In order to reduce the requirements for obtaining memory access control attributes from the memory access control circuitry, the processing circuitry is configured, when issuing the memory access request, to determine whether the target address falls within the current region of address space. When the target memory address does fall within the current region of address space, the processing circuitry can trigger the memory access control circuitry to omit performing the attribute lookup. As a result, there is a reduction in latency because the processing circuitry does not need to wait for a response from the memory control circuitry, but instead, the processing circuitry and the memory control circuitry can utilise the previously retrieved memory access control attribute(s) when accessing the target address. In other words, the processing circuitry is not required to perform the attribute lookup (which may comprise a lookup in the attribute storage circuitry and in one or more registers defining memory access control attributes for particular address regions) for every memory access request, but only for memory access requests that cause a region boundary (i.e., a boundary between different regions of the address space) to be crossed.

In some configurations the current region identifying information is suitable for storing information indicative of a current region of address space having a size greater than a smallest addressable unit of the address space (e.g., the size of the smallest amount of the address space that can be accessed without also simultaneously accessing a region of address space contiguous with the addressed region). In some configurations the smallest addressable unit of the address space is a cache line size.

The regions of address space may be of the same size. However, in some architectures the sizes of different regions of address space are configurable. For example, dependent on the use case, multiple regions of address space could be defined with either the same or different sizes and/or with sizes that are not predetermined or hard wired into the apparatus. In some configurations the attribute storage circuitry configured to support at least two regions of address space being of different sizes. In such configurations, the attribute storage circuitry may store an indication of the range of target addresses that fall within the address space for each of the regions of address space. The regions of address space may be defined by any two of: a base address indicating the start of the region of address space, a limit address indicating the end of the region of address space, and an address space size indicating a size of the region of address space. The regions of address space may be defined as aligning to particular address range boundaries allowing for a reduction in the data required to store the base address, the limit address and/or the size of the address space. However, in some configurations the regions of address space may be defined at the granularity level of the smallest addressable unit of the address space (e.g., the size of the smallest amount of the address space that can be accessed without also simultaneously accessing a region of address space contiguous with the addressed region). For example, in some configurations the regions of address space may have a 32-byte or a 64-byte granularity with no further restrictions on the alignment of the regions to particular address range boundaries. In such architectures, the provision of the current region identifying information is particularly advantageous. This is because, unlike an architecture in which the regions of address space are of fixed size, in order to determine whether a target address falls within a given region of address space, two comparisons must be performed. The first comparison determines whether the target address is greater or equal than the base address. The second comparison determines whether the target address is less than or equal the limit address. It will be readily apparent to the skilled person that these conditions could be adapted when the given region of address space is specified using different information (as discussed above). Furthermore, in some configurations, one or both of the greater than or equal to condition and the less than or equal to condition could be replaced with a greater than condition or a less than condition. When both of these conditions are satisfied it can be determined that the target address falls within the given region of address space. Therefore, in order to determine which of a plurality of regions of address space the target address falls in, two comparisons need to be performed for each of those regions. Such lookups can be particularly burdensome in terms of both power and circuit area. By reducing the frequency (rate) at which these lookups are performed, through the provision of the current region identifying information, a greater power efficiency can be achieved.

In some configurations the memory access control circuitry is responsive to the lookup identifying an entry of the plurality of entries to return information indicative of the corresponding region of address space to the processing circuitry to trigger the processing circuitry to update the current region identifying information based on the corresponding region of address space. The current region identifying information can therefore be updated in response to the lookup, i.e., when the target address is determined to fall outside of the existing current region identifying information (so that the lookup in the attribute storage circuitry is carried out), the current region identifying information can be replaced by the region identifying information returned by the lookup. This mechanism ensures that the current region identifying information remains up to date, for example, in response to a change in the processing activities of the processing circuitry to perform processing using data (which may include data representative of instructions) in a different region of memory.

In some configurations the memory access control circuitry is responsive to the lookup identifying the entry of the plurality of entries to mark the entry in the attribute storage circuitry as invalid. Once the entry has been passed to the processing circuitry to be stored as the current region identifying information, it may be beneficial to invalidate the entry in the attribute storage circuitry (e.g., by setting a particular bit, or by setting the entry to a null value). This approach can be used to free up space in the attribute storage circuitry for further entries, and to prevent a future lookup in the attribute storage circuitry from performing a lookup in the entry that identifies the same region of address space as the current region identifying information. This approach reduces the power requirements for lookups in the event that the target address is not comprised in the current region of address space. In some configurations, the entry in the attribute storage circuitry may be marked as being the entry represented by the current region identifying information. In the event of a subsequent attribute lookup (caused as a result of a miss in the current region identifying information), a lookup on this entry can be omitted and, subsequently, the mark indicating that the entry is represented by the current region identifying information can be cleared. This approach retains the entry for future use but avoids including that entry in the attribute lookup resulting in an improved power efficiency.

Whilst the current region identifying information may be stored in any form, in some configurations the current region of address space is bounded by a first limit address and a second limit address; and the processing circuitry is configured to identify at least one of the first limit address and the second limit address as the current region identifying information. The current region identifying information may therefore comprise both of the first limit address and the second limit address or only one of the first limit address and the second limit address. The first limit address may be a base address indicative of a lowest address being included in the current region and the second limit address may be a limit address indicative of a highest address being included in the current region. Alternatively, the limit address may be indicative of a lowest address not included in the current region.

In some configurations the processing circuitry is configured to discard the other of the first limit address and the second limit address. Whilst it may seem counter intuitive to only store one of the first limit address and the second limit address, there may be some use cases where it is beneficial to do so. For example, where a sequence of addresses is identified as being monotonic, there would be no need to store both of the first limit address and the second limit address. Rather, the memory access control circuitry may be configured to store whichever of the first limit address and the second limit address will be exceeded by the monotonic sequence of memory addresses and to discard the other. The memory control circuitry can therefore be configured determine if the stored one of the first limit address or the second limit address has been exceeded by performing a single comparison. The memory access control circuitry may also be configured to determine if the sequence of memory access requests deviates from being monotonic and, in that event, may be configured to trigger the attribute lookup in the attribute storage circuitry.

In some configurations the processing circuitry comprises control circuitry configured to identify when the target address will fall outside of the current region of address space based on an observed sequence of memory accesses. The observed sequence may be any type of observed sequence. For example, the sequence may be a strided sequence of memory access requests with each observed memory access request identifying a target address that is different from a preceding target address by a same stride length. Alternatively, the control circuitry may be configured to identify a more complex access pattern, such as a nested stride pattern, or a pattern that is generally monotonic.

In some configurations the control circuitry is configured to identify a pattern of target addresses in the observed sequence of memory addresses; and the control circuitry is configured to calculate a number of remaining requests, identifying target addresses within the current region, that can be issued according to the pattern of target addresses and to trigger the memory access control circuitry to omit performing the attribute lookup until the number of remaining requests in the pattern of target addresses have been issued. The control circuitry may be arranged to identify a particular pattern, for example, a stride pattern having a single stride length, or a more complex stride pattern having a non-constant stride length. Once the pattern has been identified, the control circuitry can determine how many access requests can be received according to the pattern before the target addresses will fall outside of the current region. The control circuitry can then set, as the current region identifying information, a counter indicative of the number of access requests that can be received before the target addresses will fall outside the current region. The counter may then be decremented for each received access request and a lookup by the memory access control circuitry can be triggered once the counter reaches zero. This approach avoids the requirement to perform comparison operations to determine if the target memory address falls within the current region of address space.

In some configurations the control circuitry is responsive to identification that the target address that does not fit the pattern, to trigger the memory access control circuitry to perform the attribute lookup. This approach avoids the need to store the first limit address and/or the second limit address and therefore reduces the storage overhead for the current region identifying information. Alternatively, in some configurations the memory access control circuitry is configured to also store information indicative of the first limit address and the second limit address, and, in the event that the target address does not fit the pattern, to perform one or more comparisons of the target address against the first limit address and/or the second limit address. This approach reduces the need to compare against the first and/or second limit address on each memory access but allows a comparison to be performed against those limits in the event that the sequence of access requests deviates from the expected pattern without requiring the attribute lookup to be performed in the attribute storage circuitry.

Whilst the observed sequence may be any observed sequence of data accesses or instruction accesses, in some configurations the observed sequence of memory accesses is a sequence of instruction fetch requests, each of the sequence of instruction fetch requests identifying a block of instructions; and the processing circuitry is responsive to a branch instruction identifying a target block of instructions, to calculate whether the target block of instructions falls within the region and, when the target block of instructions does not fall within the region, to trigger the memory access control circuitry to perform the attribute lookup. Fetching instructions using fetch circuitry is a use case in which memory accesses are likely to follow a predefined pattern. For example, in the absence of control flow altering instructions (i.e., any instruction that causes a deviation from the sequential flow of instructions, e.g., a branch instruction), the target address identifying the instructions to be fetched (e.g., a program counter value or an instruction pointer value) will be sequentially incremented by a size of the block of instructions to identify the next block of instructions. In other words, code being processed within a given execution context is expected to be contained within one or a small number of regions of address space so that sequential instruction fetch requests will continue to hit against the same region or against the same small set of regions. When a branch instruction is identified or predicted to occur within the sequence of instructions, the address of the next block of instructions, i.e., the target address of the target block of instructions, may fall outside of the current region. Hence, the processing circuitry is responsive to the branch instruction being identified to determine if the target address falls within the current region. This determination may be performed, for example, through comparison against the base address and the limit address of the current region. Alternatively, in some configurations, the determination may be achieved by estimating a number of blocks of instructions between the current address in the sequence of memory addresses and the target address and comparing the estimated number of blocks against a previously calculated number of sequential blocks that can occur before the address falls outside of the current region. In some configurations, the determination may be a determination of whether the target block is the sequentially next block and, if not, triggering the attribute lookup.

Whilst common attribute storage circuitry can be provided to hold memory access control attributes associated with data or instructions, in some configurations the attribute storage circuitry is partitioned into an instruction attribute partition comprising a plurality of instruction entries and a data attribute partition comprising a plurality of data entries; and the memory access control circuitry is configured: to identify whether the memory access request is an instruction fetch request or a data fetch request; when the memory access request is the instruction fetch request, to perform the lookup in the instruction attribute partition; and when the memory access request is the data fetch request, to perform the lookup in the data attribute partition. The data attribute partition and the instruction attribute partition may be physically located in a same location in the apparatus, i.e., may be provided as a same storage circuit. Alternatively, the instruction and data attribute partitions may be separated from one another with each partition located physically close to the portion of the processing circuitry configured to retrieve the data or partitions. For example, the instruction attribute partition may be located close to the instruction fetch circuitry, and the data attribute partition may be located physically closer to the load/store unit.

In some configurations the instruction attribute partition comprises a different number of entries to the data attribute partition. In some use cases, the number of regions of address space spanned by one of instructions or data is likely to be smaller than the number of regions of address space spanned by the other of instructions or data. As a result, the frequency with which different memory access control attributes are required for each of the types of access requests could vary dependent on the type of requests. It may therefore be more efficient to have a different number of entries in each of the data access partition and the instruction access partition. In some configurations the processing circuitry is configured to store only one of current region identifying information for the instruction attribute partition and the data attribute partition and to perform the attribute lookup for the other of the current region identifying information for the instruction attribute partition and the data attribute partition. In such configurations, the current region storage information may replace one of the entries in the attribute storage circuitry. For example, rather than providing N entries for each of the instruction attribute partition and the data attribute partition, the current region identifying information may be used to store one of the N entries for, e.g., the instruction attribute partition and attribute storage circuitry may therefore only provide N-1 entries for the instruction attribute partition. In such configurations, the additional circuitry required to provide the current attribute storage can result in a lower overall increase in circuitry as fewer entries could be provided in the attribute storage circuitry. Alternatively, one of the N entries that would previously have been used for the instruction attribute partition can be repurposed as an additional entry for the data attribute partition resulting in an increase in the coverage provided by the attribute storage circuitry for the data partition. In some configurations the instruction attribute partition comprises fewer entries than the data attribute partition.

In some configurations the memory access circuitry is responsive to one of the instruction entries being identified in the current region identifying information, to reassign that one of the instruction entries to the data attribute partition. The entries in the attribute storage circuitry can therefore be dynamically reassigned during operation. In addition to providing a greater storage capacity for the data attribute partition, this approach can be used to assign lookup circuitry that was previously used for the instruction attribute partition to be reassigned to the data attribute partition resulting in a more efficient lookup process in the data attribute partition.

Whilst, in some configurations, only one set of current region identifying information may be stored, in some configurations the current region identifying information comprises current data region identifying information and current instruction region identifying information. The current data region identifying information may be stored, for example, in or near to a load/store unit in the processing circuitry. The current instruction region identifying information may be stored, for example, in or near to an instruction fetch unit in the processing circuitry.

In some configurations the processing circuitry is responsive to an invalidation trigger indicating an invalidity of the current region of address space, to mark the current region of address space as invalid and to trigger the memory access control circuitry to perform the attribute lookup in response to a sequentially next memory access request. The invalidation trigger may be issued in response to any change to the memory control attributes. For example, when a change is made to a definition of a region or to a memory access control attribute associated with a region, the invalidation trigger may be issued to cause the processing circuitry to mark the current region of address space as invalid. In some configurations the invalidation trigger may be a generic invalidation trigger, for example, issued in response to identifying that any one of the plurality of regions of address space (or a memory control attribute associated with one of the plurality of regions of address space) has been changed. Alternatively, in some configurations, the invalidation trigger may identify a region of address space that has changed (or for which a memory access control attribute associated with that region changed). In such configurations, the processing circuitry is configured to compare the region of address space identified by the invalidation trigger against the region of address space identified in the current region identifying information and, when the current region identifying information identifies the region of address space for which the invalidity trigger was triggered, the processing circuitry is configured to mark the current region identifying information as invalid so that the sequentially next memory access causes the attribute lookup to be performed. On the other hand, when the region of address space identified by the current region identifying information is different from the region of address space for which the invalidity trigger was triggered, the processing circuitry may be configured to discard the invalidity trigger. The current region identifying information can be marked as invalid in a variety of ways. In some configurations, the current region identifying information is provided with a validity bit which is set to a first value when the current region identifying information is valid and to a second value when the current region identifying information is invalid. In some configurations, the current region identifying information can be set to be invalid by setting a limit address and a base address identifying the current address range to a range that cannot be satisfied by any address. For example, the limit address could be set to a lower value than the base address such that no target address could meet the conditions of being both higher than the base address and lower than the limit address. Alternatively, where only one of the base address and the limit address is stored in the current region identifying information, that one of the base address or the limit address could be set to an extremum value that cannot be met by any target address. For example, if the base address is stored, it could be marked as invalid by setting it to a highest possible address value, or if the limit address is stored, it could be marked as invalid by setting it to a lowest possible address value.

In some configurations the processing circuitry is configured to determine whether the target address is comprised in the current region of address space by performing at least one comparison of the target address against a limit address defining an extremum of the current region of address space. In some configurations the determination comprises performing a comparison of the target address against both of the limit address defining a maximum of the current region of address space and against the limit address defining a minimum of the current region of address space.

In some configurations the memory access control circuitry is comprised in a memory protection unit and the attribute storage circuitry is a memory protection unit cache.

Some configurations will now be described with reference to the figures.

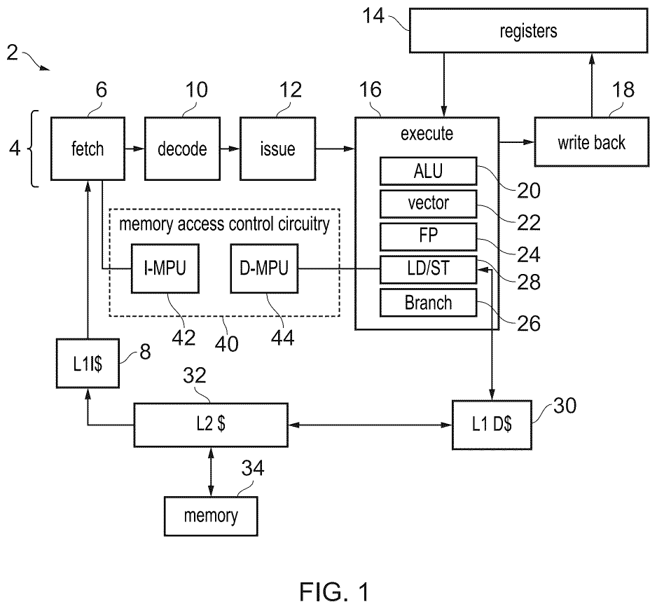

FIG. 1 schematically illustrates an example of a data processing apparatus 2. The data processing apparatus has a processing pipeline 4 which includes a number of pipeline stages. The processing pipeline 4 is an example of the processing circuitry mentioned earlier. In the example of FIG. 1, the pipeline stages include a fetch stage 6 for fetching instructions from an instruction cache 8; a decode stage 10 for decoding the fetched program instructions to generate micro-operations (decoded instructions) to be processed by remaining stages of the pipeline; an issue stage 12 for checking whether operands required for the micro-operations are available in a register file 14 and issuing micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional or fewer stages or a different configuration of stages. For example in an out-of-order processor a register renaming stage could be included for mapping architectural registers specified by program instructions or micro-operations to physical register specifiers identifying physical registers in the register file 14, or in a simpler pipeline there could be no issue stage (in FIG. 1 the issue stage provides for buffering of instructions or micro-operations while awaiting issue so that even if a given instruction is stalled awaiting its operands then the earlier pipeline stages can still proceed to fetch/decode later instructions, but if the issue stage is omitted then a stall of an instruction/micro-operation that is awaiting its operands may also cause the earlier pipeline stages to stall). In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of processing units, for executing different classes of processing operation. For example the execution units may include a scalar arithmetic/logic unit (ALU) 20 for performing arithmetic or logical operations on scalar operands read from the registers 14; a vector unit 22 for performing vector (single instruction multiple data, or SIMD) operations on vector operands comprising multiple independent data values within a single register; a floating point unit 24 for performing operations on floating-point values; a branch unit 26 for evaluating the outcome of branch operations and adjusting the program counter which represents the current point of execution accordingly; and a load/store unit 28 for performing load/store operations to access data in a memory system 8, 30, 32, 34. In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline implementation, and the processor may include many other elements not illustrated for conciseness.

Memory access control circuitry 40 is provided for controlling handling of memory access requests issued by the instruction fetch stage 6 and/or the load/store unit 28 of the execute stage 16, based on at least one memory access control attribute associated with a region of address space including the target address specified by the memory access request. A number of valid regions of address space can be defined using address-region-indicating parameters, with each valid region having an associated set of one or more memory access control attributes which can be checked to determine how a memory access specifying a target address within the corresponding region should be handled. For example, the memory access control attributes could specify access permissions which indicate the conditions under which memory accesses are allowed to the corresponding region. For example, the access permissions could restrict access to the region to software executing at a certain privilege level or in a certain mode of operation of the processing pipeline 4, or could restrict the types of accesses allowed. For example, some regions may only be allowed to be accessed for instruction accesses but not data accesses, or vice versa, while other regions may further limit which type of data accesses (reads or writes) are allowed by defining the region as read-only, or both readable and writable. Memory access control attributes can also be defined to control how memory access requests to the region, when permitted, are handled, such as defining whether it is allowable to cache data obtained from memory for the corresponding region, or whether it is permitted to reorder successive memory access requests to be performed in a different order from the order in which they were issued. For systems supporting address translation, where the addresses specified by the load/store unit 28 are virtual addresses and the memory system uses physical addresses to identify memory system locations, the memory access control attributes could also specify an address translation mapping for obtaining the physical address corresponding to the virtual address specified as the target address of the memory access. It will be appreciated that many other types of memory access control attributes could also be defined.

One approach for implementing the memory access control circuitry 40 may be to provide a memory management unit (MMU) which checks whether memory access requests satisfy access permissions specified in page tables stored in the memory system. The address space is typically divided into regions called pages which each have a size corresponding to a power of two number of bytes (e.g. 4 kilobytes), where the start and end addresses of each page are aligned to an N-byte address boundary, where N is the size of the corresponding address region. Each page table entry specifies the access permissions for a corresponding page of the address space, and often will also specify an address translation mapping for mapping a target address in a first address space (e.g. a virtual address space) to a corresponding page of addresses in a second address space (e.g. a physical address space). The page table may be implemented as a hierarchical table structure including a number of levels of page tables, where a first subset of bits of an input address indexes into a corresponding entry of a first level page table, and the indexed entry specifies the base address of a second level page table from which an entry can be indexed based on a second subset of bits of the input address, and so on for each subsequent level of the table until eventually a final level of page table is reached where the indexed entry is selected based on some bits of the address specifies. The indexed entry contains the actual address translation attributes and access permissions required for the memory accesses targeting that page. The MMU may have a cache (called a translation lookaside buffer (TLB)) which can cache certain entries of the page tables which have more recently been accessed from the memory system, so that they can be accessed again more quickly if the processing circuitry issues multiple memory access requests requiring the same page table entry. An MMU can be useful for processors designed to handle relatively high performance workloads, for which it may be acceptable and desirable to set controls over access to many different address regions, e.g. such control may be at a 4 Kbyte granularity, and for which arbitrary mappings of address translations from any page in the first address space to any arbitrary page in the second address space may be required in order to handle accesses triggered by a number of different software processes which use the same virtual address but need to be mapped to different physical addresses used by the memory system.

However, for processors aimed at more energy-efficient workloads or designed for real time applications, an MMU may be unsuitable as the large page table structures used to define the access permissions to individual pages, and the granularity of control, may be too large for the constrained memory environment typically seen in systems aimed at more energy-efficient lower performance applications, which can have as little as two kilobytes of random access memory (RAM). Also, to facilitate using a subset of the input address bits as an index into the page tables, an MMU typically constrains each page to have a size corresponding to a power of two number of bytes. This means that if it is desired to set a certain set of access permissions only for a certain address region which has a size other than a power of two number of bytes, this would have to be represented using a number of separate page table entries each corresponding to a smaller page of a power of two number of bytes in size, with each of those individual page table entries defining exactly the same access permissions so that the set of page table entries as a whole corresponds to the larger non-power of two sized address region. This artificial partition of an address region into multiple pages is a consequence of the restriction of the page alignment to address boundaries corresponding to the size of the page, which is required in MMUs in order to enable an efficient indexing procedure using a whole number of bits from the input address for indexing into the hierarchical page structures used to cover a large address space.

However, this approach may cause problems for real time program code because it means that within a piece of program code or data intended to be governed by a given set of access permissions, the memory accesses may cross a page boundary between pages corresponding to different page table entries of the page tables, and so if the page table entry for the new page is not already cached in the MMU then this may require a page table walk to be performed to fetch the required page table entry from memory, partway through execution of a section of program code. Also, if on reaching the page boundary, it is found that the page table entry for the next page has not yet been defined in the page tables, this may cause a fault which may be slow to deal with as it may require a software exception handler to trigger an operating system or other supervising process to set the page table entry to map the required page, causing a long delay. Such delays can be highly variable and in the worst case may be extremely long, and if the section of program code issues memory accesses to addresses spanning more than two different pages then at each page boundary such delays can be incurred again. This makes it very difficult for an MMU to be able to satisfy the requirement in real time applications to have deterministic response times.

Another approach for the memory access control circuitry 40 to control access to memory can be to provide a memory protection unit (MPU), which checks whether memory access requests issued by the processing circuitry satisfy access permissions specified in a number of memory protection entries (the MPU is an example of memory access control circuitry described above). Each memory protection entry may correspond to a particular address region of variable size within the address space. The corresponding address region for a given memory protection entry can be bounded by start and end addresses which are identified through separately-specified parameters of the given memory protection entry (e.g. using explicit start/end addresses, or through a start or end address and a size parameter). Unlike for the page tables used by an MMU, for an MPU the region corresponding to a memory protection entry may have a variable size which may be permitted to be a number of bytes other than a power of two. With this approach, it can be guaranteed that a memory address region of an arbitrary (non-power of 2) size can be defined using a single memory protection entry, to avoid the risk of page walks and page faults occurring each time address accesses cross a page address boundary. This makes an MPU more suitable for systems designed for processing real time applications.

In some MPU implementations, the MPU stores each of the memory protection entries within registers provided locally in hardware within the MPU, which can be fast to access, again assisting with real time processing and avoiding the need for storing large page tables having a hierarchical structure within the memory system, which can be important for systems with limited RAM. However, in systems where all the MPU entries are stored locally within hardware registers, as the registers which are typically directly connected to a parallel bank of comparators for comparing the target address to be accessed with the region identifying parameters of each memory protection entry stored in the registers, and each region may require separate comparisons against the start and end boundaries of the region, the power and area associated with an MPU scales badly as the number of memory protection entries supported by the MPU increases. In practice, this may mean that the number of memory protection entries supported may be limited to a relatively small number, e.g. 8 or 16. The limited number of memory protection entries in a typical MPU may cause an impact on the performance achieved by software executing on the processing system. For example, a piece of software may require a greater number of distinct address regions to be defined with different access permissions than is supported in hardware in the number of protection entries supported by the MPU. In this case, at any given time at least some parts of the address space required to be accessed by that software will not currently have a corresponding memory protection entry defined for it. This would mean that an access to an address in a currently undefined region of the address space would trigger an exception which would then require software to step in and reconfigure the registers of the MPU, so as to overwrite the parameters previously defined for a different region with the parameters required for the region needed to be accessed now. If a later instruction then accesses the previously defined region which has been overwritten, this may then cause the MPU configuration to be switched back again. This constant switching of the contents of the MPU registers, needing an exception to trigger the switching each time, may greatly harm performance. Another example can be where the processor needs to execute multiple pieces of software which are mutually distrustful, but which need to share data between them. To enable the sharing of data a given piece of software may wish to divide up portions of the address space so that only limited portions of the address space are accessible to other processes, but to provide such fine degree of control over access to the address space, this may require additional address regions to be defined, and there may not be enough spare memory protection entries supported by the MPU in hardware to allow such fine grained control. Hence, in practice the same data may end up being copied into multiple parts of the address space, one copy in the part accessed by the first software and another in the part accessed by the second software, which results in time being wasted to perform the copying and inefficient use of the memory capacity available, which can be a particular problem in systems with constrained memory resources.

Hence, some MPU implementations may also support MPU entries being obtained from a memory-based memory protection table including a number of memory protection entries which each specify access permissions for a corresponding address region of variable size within an address space, each entry also specifying region identifying parameters for identifying a start address and an end address of the corresponding address region. The MPU permits the variable size to be a number of bytes other than a power of 2, and MPU memory access circuitry can be provided to initiate at least one memory access request for accessing the memory protection table from the memory system. Hence, by providing the memory protection table in the same memory system for which access is policed by the MPU, this provides the flexibility to provide a greater number of memory protection entries then is practical for a typical MPU restricted to checking entries defined in hardware-based registers storing region defining data for each entry which is compared in parallel to a target address. In addition to the support for accessing the memory protection table defined in the memory, a set of hardware-based registers can be provided within the MPU along with attribute storage circuitry, for caching a subset of the MPU entries from the memory-based memory protection table, and/or for supporting definition of a static set of MPU entries which can be configured for relatively frequently accessed regions of memory to provide a faster lookup for those frequently accessed lookups. By combining caching and/or statically defined entries with a wider set of entries defined in the memory-based table which can be accessed in cases when a lookup misses in the cached/statically-defined entries, this can provide a balance between performance (based on support for a larger set of memory regions overall) and reduced hardware/power overhead (as it is not necessary to allocate a total number of sets of registers and associated comparison circuitry corresponding to every region for which MPU data is defined in the memory-based table).

As shown in FIG. 1, in some implementations separate memory access control units may be provided for controlling attribute lookups for instruction accesses initiated by the fetch stage 6 and data accesses initiated by the load/store unit 28 respectively. For example, the memory access control circuitry 40 may include an instruction MPU 42 for controlling attribute lookups for the instruction fetch accesses and a data MPU 44 for controlling attribute lookups for the data accesses.

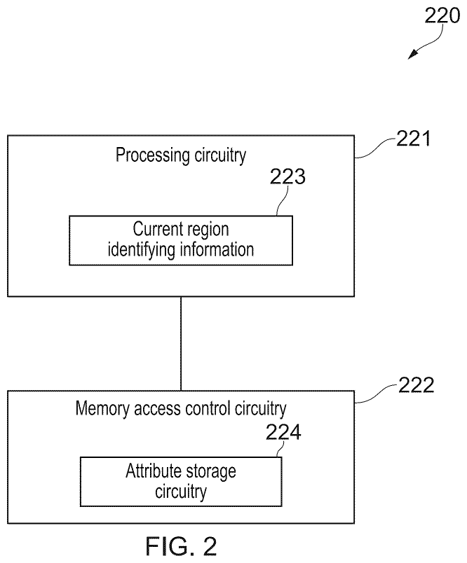

FIG. 2 schematically illustrates an apparatus 220 according to some configurations of the present techniques. The apparatus comprises processing circuitry 221 and memory access control circuitry 222. The processing circuitry 221 is arranged to perform processing activities in response to a sequence of instructions and may be arranged, for example, like the processing pipeline 4 of FIG. 1. It will be readily apparent to the skilled person that the processing pipeline 4 of FIG. 1 is one possible example of processing circuitry, and the processing circuitry may be arranged in a different way and/or include many other elements.

The memory control circuitry 222 is provided to control handling of memory access requests based on memory access control attributes that are associated with a corresponding region of address space. In particular, the memory control circuitry 222 is provided with attribute storage circuitry 224 which is configured to store a plurality of entries which each identify a corresponding region of address space and information indicating at least one corresponding memory access control attribute for the corresponding region of address space. For example, the one or more memory access control attributes may comprise memory access permissions and/or restrictions on whether accessed content is permitted to be cached. Further examples of memory access control attributes may include any of the memory access control attributes described above.

In response to receipt, from the processing circuitry 221, of a memory access request identifying a target address, the memory access control circuitry 222 performs a lookup to determine if the target address falls within one of the regions of address space identified by an entry stored in the attribute storage circuitry 224. When the target address results in a hit on an entry in the attribute storage circuitry 224, the memory access control circuitry 222 controls the memory access based on the memory access control attributes identified in the entry. When the target address results in a miss in the attribute storage circuitry 224, the memory access control circuitry 222 may perform a lookup for the memory access control attributes in the memory hierarchy.

In addition, the processing circuitry 221 is provided with current region identifying information 223. The current region identifying information 223 is information indicative of a current region of address space and at least one current memory access control attribute associated with the current region of address space. The provision of the current region identifying information 223 enables the processing circuitry 221, when the target address identified in a memory access request falls within the current region of address space, to perform the memory access without triggering a lookup in the attribute storage circuitry 224. Because the current region identifying information identifies a smaller number of regions than the entries in the attribute storage circuitry (for example, the current region identifying information may identify only a single region of address space), the total number of lookups is reduced for memory access requests that fall within the current region of address space identified in the current region identifying information. Furthermore, because the current region identifying information 223 is provided in the processing circuitry 221, the latency associated with the lookup in the current region identifying information 223 is lower than the latency associated with performing lookups in the attribute storage circuitry 224.

Where the lookup in the current region identifying information 223 results in a miss, e.g., the processing circuitry 221 determines that the target address falls outside of the current region of address space, or the processing circuitry 221 is not able to positively determine that the target address falls inside the current region of address space, then the memory access request is passed to the memory access control circuitry 222 to perform the attribute lookup in the attribute storage circuitry 224. Once the memory access control circuitry 222 has identified the memory access control attribute for the memory access requests, e.g., a hit in the attribute storage circuitry 224 or identification of memory access control attributes for a region of address space comprising the target address as a result of a lookup in the memory hierarchy, the memory access control circuitry 222 triggers the processing circuitry 221 to update the current region identifying information 223 to replace the previous current region identifying information 223 with the region identifying information that resulted in the hit. In this way, the current region identifying information is maintained as indicative of a most recently accessed region of address space.

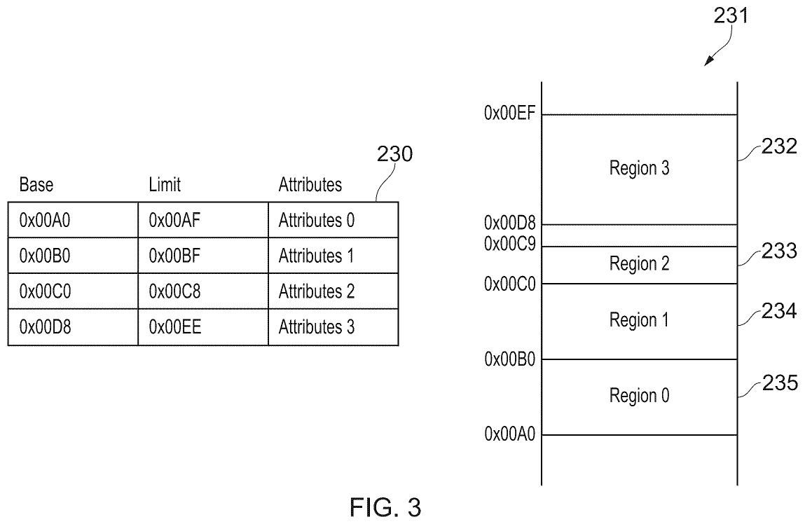

FIG. 3 schematically illustrates a plurality of entries 230, e.g., entries of the attribute storage circuitry, identifying regions of address space 231. The memory access control circuitry 222 supports regions of address space having different sizes which are identified by a base address and a limit address. In the illustrated example, the plurality of entries 230 identifies a first region 235, region 0, having a base address 0x00A0 and a limit address of 0x00AF a target address falls within the first region 235 when the target address is greater than or equal to the base address 0x00A0 and the target address is less than or equal to the limit address 0x00AF. The plurality of entries 230 also identifies a second region 234, region 1, having a base address 0x00B0 and a limit address of 0x00BF a target address falls within the second region 234 when the target address is greater than or equal to the base address 0x00B0 and the target address is less than the limit address 0x00BF. The plurality of entries 230 also identifies a third region 233, region 2, having a base address 0x00C0 and a limit address of 0x00C8 a target address falls within the third region 233 when the target address is greater than or equal to the base address 0x00C0 and the target address is less than the limit address 0x00C8. The plurality of entries 230 also identifies a fourth region 232, region 3, having a base address 0x00D8 and a limit address of 0x00EF a target address falls within the third region 232 when the target address is greater than or equal to the base address 0x00D8 and the target address is less than the limit address 0x00EF. By defining each of the plurality of regions in terms of a base address and a limit address, the regions of address space can be of the same size or can have one or more regions of address space that are of different sizes. The regions of address space can be arranged as contiguous or non-contiguous regions of address space.

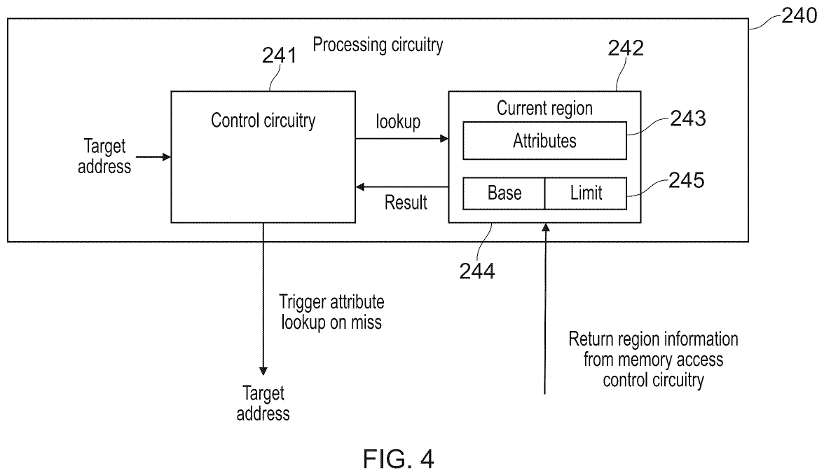

FIG. 4 schematically illustrates further details of processing circuitry 240 according to some configurations of the present techniques. The processing circuitry 240 is provided with control circuitry 241 and current region identifying information 242. The current region identifying information 242 includes a base address 244 indicative of a lower limit of the current region of address space and a limit address 245 indicative of an upper limit of the current region of address space. The current region identification information also includes one or more memory access control attributes 243 for the current region of address space. The control circuitry 241 is configured to receive a memory access request identifying a target address before a lookup is performed in the memory access control circuitry and to perform a current region lookup in the current region identifying information. In the illustrated configuration the lookup comprises performing at least one comparison between the target address and the limit address 245, and between the target address and the base address 244. When the lookup results in a hit (i.e., the target address is determined to fall within the region of address space defined by the base address 244 and the limit address 245), the control circuitry 241 causes the memory access to be performed based on the memory access control attributes 243 comprised in the current region storage circuitry 242. When the lookup results in a miss (e.g., the target address is determined to fall outside of the region of address space defined by the base address 244 and the limit address 245), the control circuitry 241 triggers an attribute lookup based on the target address. The current region storage circuitry 242 is also configured to receive region information returned from memory access control circuitry indicative of a current region of address space identified as a result of the attribute lookup and, in response to receipt of the region information, to update the base address 244, the limit address 245, and the memory access control attributes 243 in the current region storage circuitry 242.

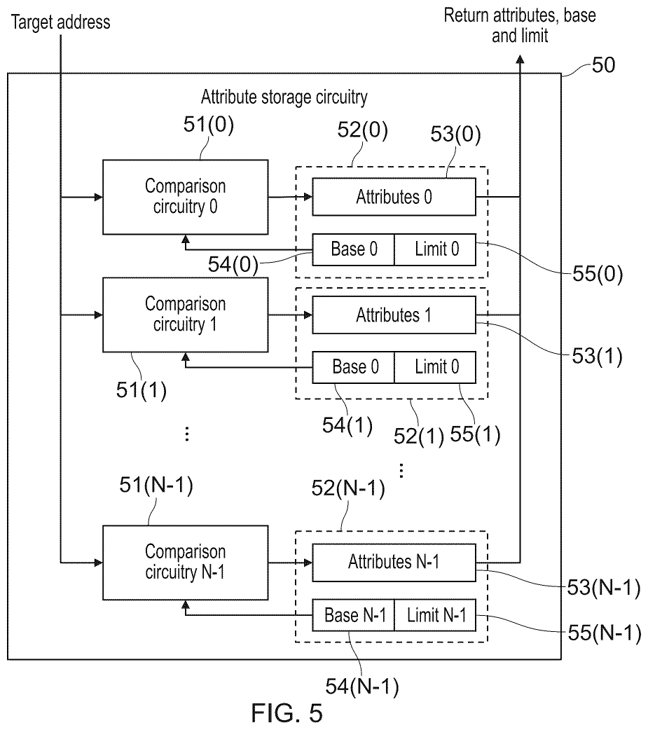

FIG. 5 schematically illustrates attribute storage circuitry 50 according to some configurations of the present techniques. The attribute storage circuitry 50 is configured to store a plurality of entries 52. In the illustrated configuration, the plurality of entries 52 comprises N entries labelled from entry 0 52(0) to entry N-1 52(N-1). Each of the plurality of entries 52 comprises memory access control attributes 53, a base address 54 and a limit address 55. Each entry of the attribute storage circuitry is provided with comparison circuitry 51 configured to receive a target address and to perform comparisons to determine if the target address falls within the region of address space identified by the base address 54 and the limit address 55. If the comparison circuitry 51 determines that the target address falls within the region of address space identified by the base address 54 and the limit address 55, then the memory access control attributes 53, the base address 54, and the limit address 55 are returned.

In the illustrated configuration each entry 52 is provided with its own dedicated comparison circuitry 51. In particular entry 0 52(0) is provided with comparison circuitry 0 51(0), entry 1 52(1) is provided with comparison circuitry 1 51(1), through to entry N-1 52(N-1) which is provided with comparison circuitry N-1 51(N-1). Because the entries 52 can each define a region of memory address space having a different size, the comparison circuitry has to perform comparisons to determine both of whether the target address is greater than or equal to the base address 54 for each entry and whether the target address is less than or equal to the limit address 55 for each entry. These comparisons can be expensive and require a greater amount of power than, for example, a lookup in which each region of address space is of a same size.

It will be readily apparent to the skilled person that, whilst the number of comparison circuits 51 in the illustrated configuration is equal to the number of entries 52, in some alternative configurations a small number of comparison circuits 51 could be provided and the lookup could be performed, at least partly, in a serial manner. This approach would reduce circuit area but may result in an increased latency and power consumption.

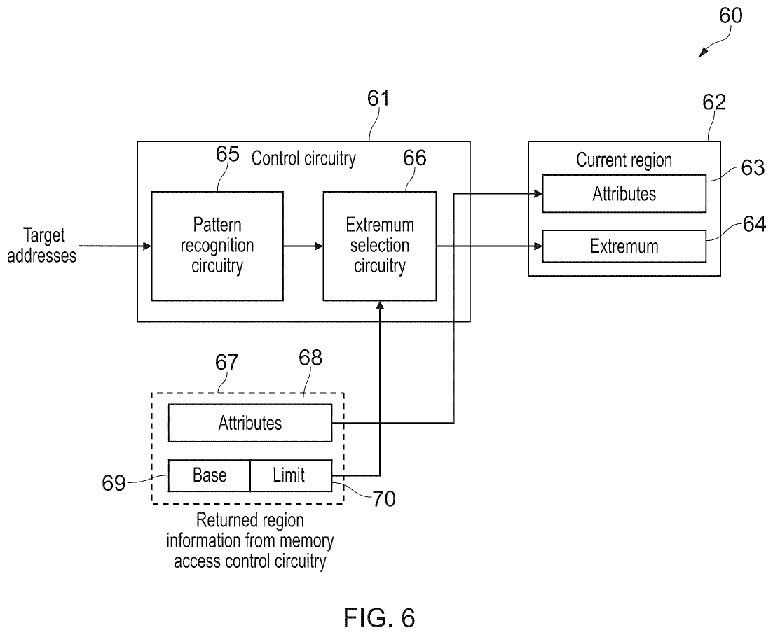

FIG. 6 schematically illustrates details of processing circuitry 60 according to some configurations of the present techniques. The processing circuitry 60 comprises control circuitry 61 and current region identifying information 62. The current region identifying information 62 comprises memory control attributes 63 associated with the current region of address space and an indication of an extremum 64 of the current region of address space. The extremum 64 stores an indication of one of a current base address and a current limit address of the current region of address space and does not store the other one of the current base address and the current limit address.

The control circuitry 61 is provided with pattern recognition circuitry 65 and extremum selection circuitry 66. The pattern recognition circuitry 65 is configured to monitor a sequence of target addresses to identify whether the sequence of target addresses is a sequence of increasing target addresses or a sequence of decreasing target addresses. The pattern recognition circuitry 65 indicates whether the sequence is an increasing sequence of a decreasing sequence to the extremum selection circuitry 66. For an increasing sequence of addresses, the control circuitry 61 is configured to determine whether the target address is less than or equal to a limit address stored as the extremum 64 in the current region identifying circuitry 62. For a decreasing sequence of addresses, the control circuitry 61 is configured to determine whether the target address is greater than or equal to a base address stored as the extremum 64 in the current region identifying circuitry 62. When the target address is determined to fall inside the region identified by the extremum 64 When the target address is determined to fall outside of the region identified by the extremum 64, then the control circuitry 61 is configured to perform an attribute lookup in the attribute storage circuitry. The control circuitry is further responsive to the pattern recognition circuitry 65 identifying a change in direction of the pattern of target addresses to trigger the memory access control circuitry to perform an attribute lookup based on the target address.

The control circuitry 61 is responsive to receipt of returned region information 67 from the memory access control circuitry to store memory access control attributes 68 identified in the returned region information 67 as the memory access control attributes 63 in the current region identifying information and to store one of the base address 69 and the limit address 70, identified in the returned region information 67, as the extremum 64 in the current region identifying information 62. The extremum selection circuitry 66 is configured to select between the base address 69 and the limit address 70 based on whether the pattern recognition circuitry 65 has identified an increasing pattern or a decreasing pattern. In particular, when the pattern recognition circuitry 65 has identified an increasing pattern, the extremum selection circuitry 66 is triggered to select the limit address 70 to be stored as the extremum 64 in the current region identifying information 62. When the pattern recognition circuitry 65 has identified a decreasing pattern, the extremum selection circuitry 66 is triggered to select the base address 69 to be stored as the extremum 64 in the current region identifying information 62.

By storing only one of the base address 69 and the limit address, the storage space required for the current region storage circuitry can be reduced. Furthermore, only a single lookup is required to be performed to determine whether the target address falls within the region of address space defined by the extremum. Such an approach may be particularly advantageous where the access request comprising the target address is an instruction fetch request where it can quickly be determined if the sequence of target addresses is a sequence of requests for consecutive blocks of instructions or if one or more of the sequence of requests identifies a branch instruction resulting in a change in direction of program flow.

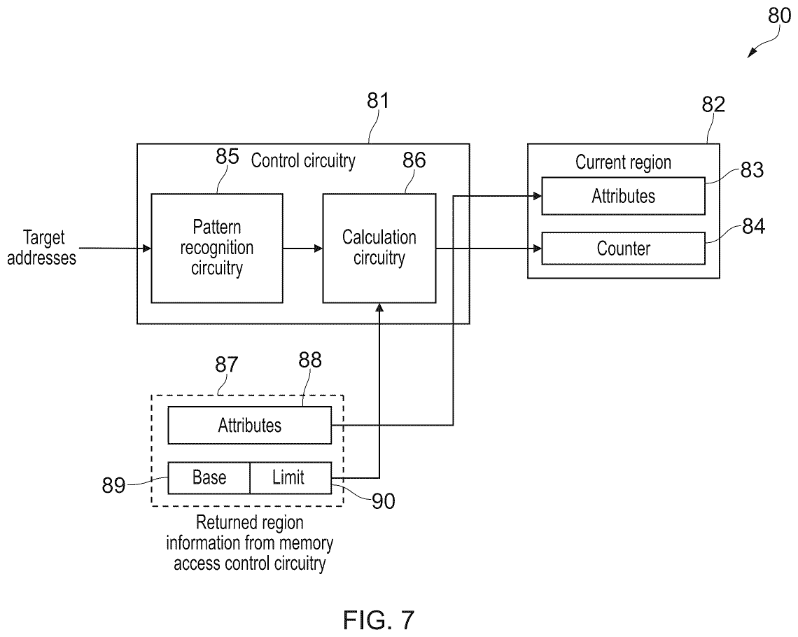

FIG. 7 schematically illustrates an alternative configuration of processing circuitry 80 according to some configurations of the present techniques. The processing circuitry is provided with control circuitry 81 and current region identifying information 82. The current region identifying information 82 identifies memory access control attributes 83 of the current region of address space and a counter 84 storing an indication of a number of target addresses that can be received according to an identified pattern before the target address falls outside of the current region of address space.

The control circuitry 81 comprises pattern recognition circuitry 85 and calculation circuitry 86. The pattern recognition circuitry 85 is configured to identify a pattern, for example, the pattern recognition circuitry 85 may identify a strided sequence of target addresses having a particular stride length. The pattern recognition circuitry identifies the stride length to the calculation circuitry 86 and also indicates when a target address is received that falls outside of the expected pattern. When the pattern recognition circuitry identifies that a target address follows an expected pattern, e.g., that the target address differs from a preceding target address by the expected stride length, then the control circuitry 81 determines if the counter 84 is equal to zero. If the counter 84 is greater than zero, then the control circuitry decrements the counter 84 and retrieves the memory access control attributes 83 from the current region identifying information. If the counter 84 is equal to zero, then the control circuitry triggers an attribute lookup to be performed in the attribute storage circuitry based on the target address. In addition, if the pattern recognition circuitry 85 determines that the target address falls outside of the expected pattern, then the control circuitry 81 triggers the attribute lookup to be performed based on the target address.

The control circuitry 81 is responsive to receipt of returned region identification information 87 from the memory access control circuitry to store memory access control attributes 88 identified in the returned region information 87 as the memory access control attributes 83 in the current region identifying information. The calculation circuitry is configured to determine, based on the pattern identified by the pattern recognition circuitry 85, the base address 89 returned in the region information 87, and the limit address 90 returned in the region information 87, to calculate the number of target addresses following the identified pattern that can be received before the target address falls outside of the region of address space defined by the base address 89 and the limit address 90 and to store the number of target addresses as the counter 84 in the current region identifying information 82.

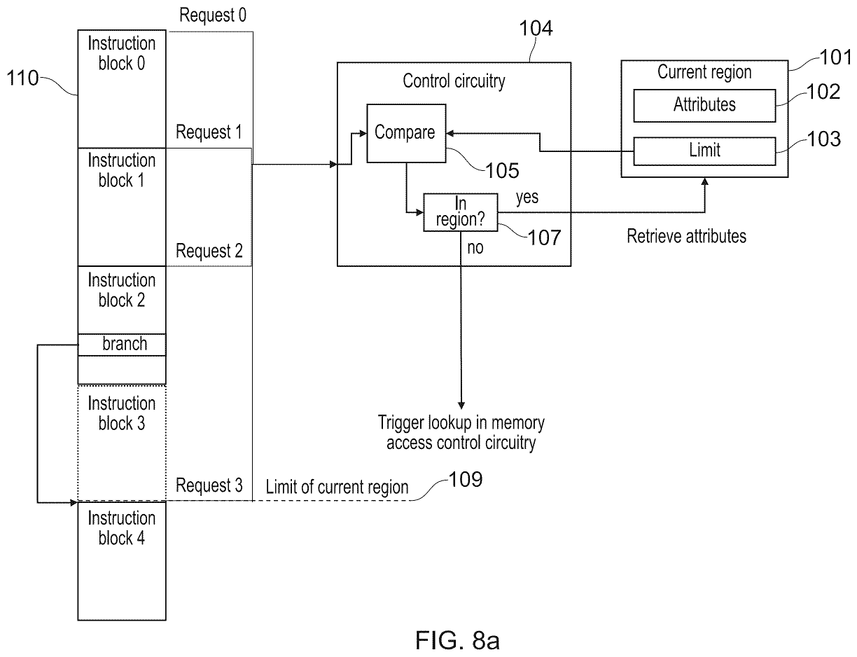

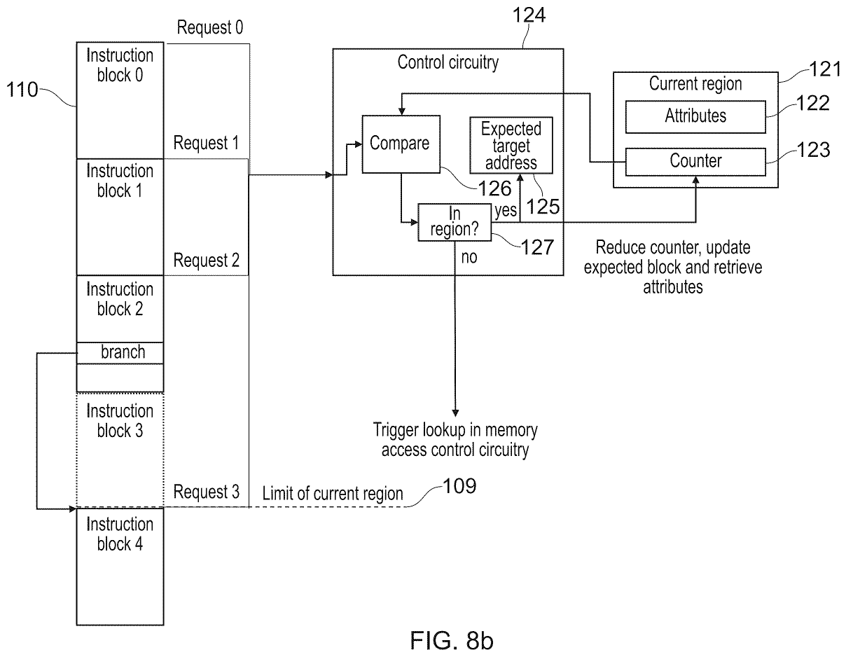

FIGS. 8a and 8b schematically illustrate an example of the response of processing circuitry to a sequence of requests according to some configurations of the present techniques. In each case the sequence of requests comprise instruction fetch requests for a sequence of blocks of instructions 110. In particular, the sequence of blocks of instructions 110 in program counter order comprise instruction block 0, instruction block 1, instruction block 2, instruction block 3, and instruction block 4. In the illustrated example, instruction blocks 0 to 3 are comprised in a same region of address space which has a limit address 109 subsequent to instruction block 3 in the address space. Instruction block 4 is comprised in a different region of address space. Whilst the instruction blocks are arranged sequentially and consecutively in address space, instruction block 2 comprises a branch instruction which causes the flow to branch from the branch instruction to a target address comprised in instruction block 4. As a result, the blocks of instruction that are required for retrieval from memory comprise instruction block 0, instruction block 1, instruction block 2, and instruction block 4.

FIG. 8a schematically illustrates a first example of processing circuitry according to some configurations of the present techniques. The processing circuitry comprises control circuitry 104 and current region identifying information 101. The current region identifying information 101 stores one or more memory access control attributes 102 associated with the current region of address space and limit information 103 identifying the limit address 109 of the current region. The control circuitry 104 comprises comparison circuitry 105 that is responsive to receipt of a request to perform a comparison between the target address identified in the request against the limit information 103 stored in the current region identifying information 101. The result of the comparison is used by determination circuitry 107 to determine if the result is in the current region. If the determination circuitry 107 determines that the target address is in the current region, then the memory access control attributes 102 are retrieved. If the determination circuitry 107 determines that the target address is not in the current region, then the memory access control attributes 102 are not retrieved and a lookup is triggered in the memory access control circuitry. In the illustrated example, request 0 for instruction block 0, request 1 for instruction block 1, and request 2 for instruction block 2 are within the region of address space identified by the limit 103. Hence, the memory access control attributes to be used to control handling of memory access requests 0 to 2 are retrieved from the current region storage circuitry. However, the branch instruction in instruction block 2 causes a jump in program flow to a different region of address space, i.e., to a target address that falls outside the limit of the current region 109. As a result, the comparison circuitry 105 determines that the target address in request 3 does not fall within the current region of address space defined by the limit 103, and an attribute lookup in the memory access control circuitry is triggered.

FIG. 8b schematically illustrates a second example of processing circuitry that tracks whether a target address falls within the current region of address space using different stored information according to some configurations of the present techniques. The processing circuitry comprises control circuitry 124 and current region identifying information 121. The current region identifying information 121 stores one or more memory access control attributes 122 associated with the current region of address space and counter information 123 identifying a number of requests that can be received according to a current pattern before the target address in one of the requests falls outside of the limit of the current region 109. The control circuitry 124 comprises comparison circuitry 126 that is responsive to receipt of a request to perform a comparison between the target address identified in the request against information indicative of an expected target address 125. In addition, the comparison circuitry receives an indication of the counter 123 and confirms that the counter value has not reached zero. The result of the comparison is used by determination circuitry 127 to determine if the result is in the current region. If the determination circuitry 127 determines that the target address is the expect target address 125 and that the counter has not reached zero, then it is determined that the target address is in the region. When the target address is determined to be in the region, the memory access control attributes 122 are retrieved, the expected target address is updated and the counter 123 is reduced. If the determination circuitry 127 determines that either the target address does not match the expected target address 125 or that the counter has reached zero, then the memory access control attributes 122 are not retrieved and a lookup is triggered in the memory access control circuitry.

In the illustrated example, it is assumed that the counter 123 has been initialised to a value of 4 prior to receipt of request 0 for instruction block 0 and that the expected target address is incremented by the size of one instruction block for each received request that falls within the expected pattern. Request 0 is assumed to follow the target pattern and on receipt, the comparison circuitry compares the target address for instruction block 0 against the expected target address 125. In addition, the comparison circuitry determines that the counter value 123 is greater than zero. In this case, the counter value is 4 and the expected target address is the address of instruction block zero. As a result, the determination circuitry 127 determines that the target address is in the region and retrieves the memory access control attributes 122 from the current region identifying information 121. The control circuitry 124 also triggers the counter 123 to be decreased to a value of 3 and the expected target address is updated to the target address of instruction block 1. This pattern is followed for request 1 with the counter being decreased to a value of 2 and the expected target address being updated to the address of instruction block 2, and is also followed for request 2 with the counter being decreased to a value of 1 and the expected target address being updated to the address of instruction block 3. The branch instruction in instruction block 2 causes a jump in program flow to a different region of address space, i.e., to a target address that falls outside the limit of the current region 109. As a result, the next memory access request (request 3) is for instruction block 4. As a result, the comparison circuitry 126 identifies that the target address is not equal to the expected target address 125 and the determination circuitry 127 triggers an attribute lookup in the memory access control circuitry.

It will be appreciated that if the branch instruction in instruction block 2 had been absent, or present but not-taken, then the next block of instructions would be instruction block 3 which would have a target address matching the expected target address causing the counter to then be decreased to a value of 0 and the expected target address to be updated to the address of instruction block 4. Subsequently if a request for instruction block 4 was received, then whilst the target address would match the expected target address 125, the counter value would be equal to zero and the determination circuitry would identify that the limit of the current region 109 had been crossed and would trigger a lookup in the memory access control circuitry.

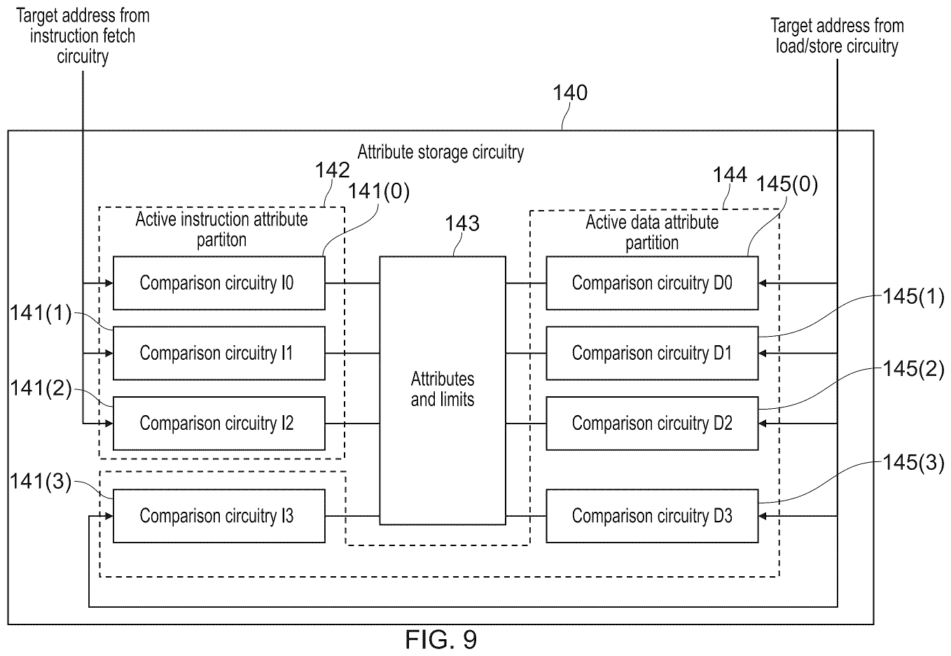

FIG. 9 schematically illustrates attribute storage circuitry 140 according to some configurations of the present techniques. The attribute storage circuitry 140 is provided with an instruction attribute partition and a data attribute partition. The instruction attribute partition comprises a plurality of sets of comparison circuits 141 including instruction attribute comparison circuitry I0 141(0), instruction attribute comparison circuitry I1 141(1), instruction attribute comparison circuitry I2 141(2), and instruction attribute comparison circuitry I3 141(3). The data attribute partition comprises a plurality of sets of comparison circuits 141 including data attribute comparison circuitry D0 145(0), data attribute comparison circuitry D1 145(1), data attribute comparison circuitry D2 145(2), and data attribute comparison circuitry D3 145(3). Each of the comparison circuits in the data attribute partition 145 and each of the comparison circuits in the instruction attribute partition 141 performs a lookup in an entry storing attributes and limit information 143 for a region of address space. The instruction attribute partition and the data attribute partition are configured as same sized partitions. However, in operation, the instruction fetch circuitry is configured, according to some configurations of the present techniques, to store current region identifying information. The attribute storage circuitry 140 is arrange, when sending the current region identifying information to the instruction fetch circuitry, to reallocate the instruction attribute partition circuitry associated with the entry that stored the instruction attribute identifying information to be part of the data partition. As a result, the attribute storage circuitry 140 comprises an active instruction attribute partition 142 comprising three of the instruction comparison circuits. The attribute storage circuitry 140 also comprises an active data attribute partition having the four comparison circuits allocated to the data attribute partition and one of the comparison circuits that was originally provided as part of the instruction attribute partition. Reallocating the comparison circuitry I3 141(3) to the active data attribute partition provides an additional entry in the attribute storage circuitry 140 for an entry defining a data region whilst maintaining a same number of entries for the instruction partition (with one of the entries provided by the current region identifying information stored in the processing circuitry). The reallocation of comparison circuitry from the instruction attribute partition to the data attribute can be performed dynamically at run time. Alternatively, the data attribute partition can be enlarged at manufacture time or at system boot according to one or more boot parameters.

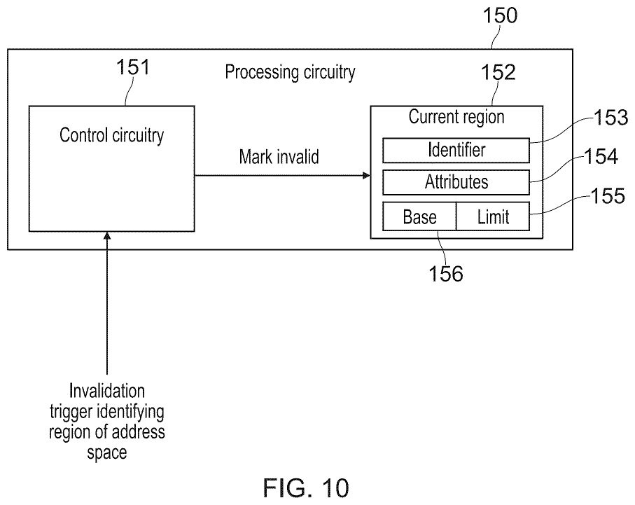

FIG. 10 schematically illustrates the response of processing circuitry 150 to an invalidation trigger identifying a region of address space. The processing circuitry 150 is provided with control circuitry 151 and current region identifying information 152. In the illustrated configuration the current region identifying information 152 comprises a region identifier 153 along with memory control memory access control attributes 154, a base address 156, and a limit address 155. The control circuitry 151 receives the invalidation trigger and performs a comparison between the region identifier 153 and an identifier provided in the invalidation trigger. In the event of a match, the control circuitry 151 marks the current region identifying information as invalid triggering a next memory access request to perform an attribute lookup in the attribute storage circuitry.

In some alternative configurations, the invalidation may trigger may be a general invalidation trigger, or an invalidation trigger with an identifier indicating a general invalidation. The control circuitry 151 is responsive to a general invalidation to invalidate the current region identifying information 152 regardless of which current region is identified so that the next memory access requests triggers an attribute lookup in the attribute storage circuitry.

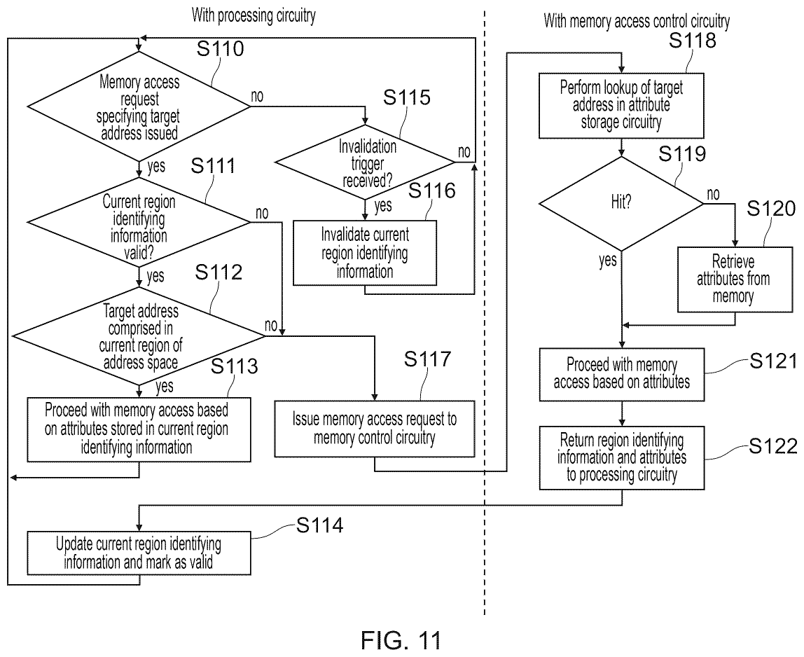

FIG. 11 schematically illustrates a sequence of steps carried out by processing circuitry and by memory access control circuitry according to some configurations of the present techniques. Flow begins with the processing circuitry at step S110 where it is determined if a memory access request specifying a target address has been issued. If, at step S110, the processing circuitry determines that a memory address specifying a target address has not been issued, then flow proceeds to step S115 where the processing circuitry determines whether an invalidation trigger has been received. If, at step S115, the processing circuitry determines that no invalidation trigger has been received (e.g., due to a modification to one of the plurality of regions of address space), then flow returns to step S110. If, at step S115, the processing circuitry determines that an invalidation trigger has been received, then flow proceeds to step S116 where the current region identifying information is invalidated by the processing circuitry. Flow then returns to step S110. If, at step S110, the processing circuitry determines that a memory access request specifying a target address has been issued, then flow proceeds to step S111 where the processing circuitry determines whether the current region identifying information is valid. If, at step S111, the processing circuitry determines that the current region identifying information is not valid, then flow proceeds to step S117. At step S117, the processing circuitry issues a memory access request to the memory control circuitry to trigger an attribute lookup to be performed before flow proceeds to step S118 which will be described below. If, at step S111, the processing circuitry determines that the current region identifying information is valid, then flow proceeds to step S112. At step S112 the processing circuitry determines if the target address is comprised in the current region of address space. If, at step S112, the processing circuitry determines that the target address is not comprised in the current region of address space, then flow proceeds to step S117 and proceeds as described above. If, at step S112, the processing circuitry determines that the target address is comprised in the current region of address space, then flow proceeds to step S113. At step S113, the processing circuitry proceeds with the memory access request based on memory access control attributes stored in the current region identifying information before flow returns to step S110.

At step S118, the memory access control circuitry performs a lookup of the target address in attribute storage circuitry. Flow then proceeds to step S119 where the memory access control circuitry determines whether the lookup resulted in a hit. If, at step S119, the memory access control circuitry determines that there was a hit in the attribute storage circuitry, then flow proceeds to step S121. If, at step S119, the memory access control circuitry determines that there was not a hit in the attribute storage circuitry (i.e., there was a miss in the attribute storage circuitry), then flow proceeds to step S120 where the memory access control circuitry retrieves the memory access control attributes from memory before flow proceeds to step S121. At step S121, the memory access control circuitry proceeds with the memory access based on the memory access control attributes retrieved from the attribute storage circuitry. Flow then proceed to step S122 where the memory access control circuitry returns the region identifying information and memory access control attributes to the processing circuitry. Flow then proceeds to step S114.

At step S144, the processing circuitry receives the returned region identifying information and memory access control attributes and updates the current region identifying information. The processing circuitry also marks the current region identifying information as valid. Flow then returns to step S110.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

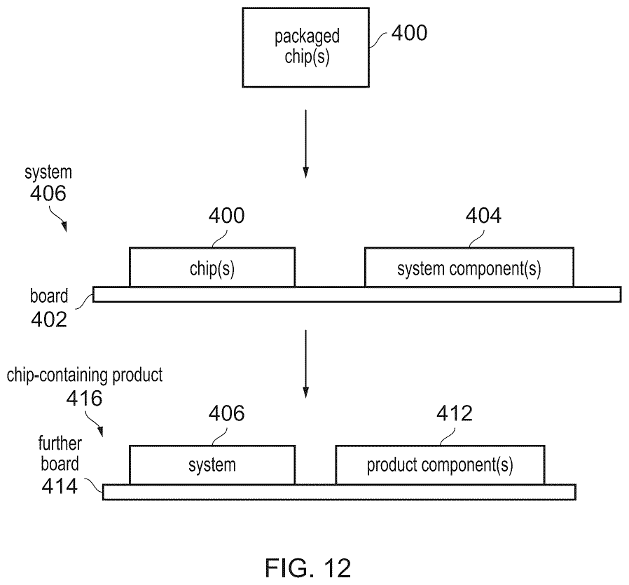

As shown in FIG. 12, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company. The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, System Verilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and System Verilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In brief overall summary there is provided an apparatus comprising processing circuitry to issue a memory access request specifying a target address. The apparatus comprises memory access control circuitry to control handling of the memory access request based on a memory access control attribute associated with the target address. The memory access control circuitry comprises attribute storage circuitry to store entries each identifying a region of address space and a memory access control attribute. The memory access control circuitry is responsive to the memory access request to perform a lookup in the attribute storage circuitry. The processing circuitry comprises current region identifying information indicative of a current region of address space and a current memory access control attribute. The processing circuitry is configured, when the target address is comprised in the current region, to indicate the current memory access control attribute to the memory access control circuitry, and to omit the lookup.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative configurations of the invention have been described in detail herein with reference to the accompanying drawings, it is to be understood that the invention is not limited to those precise configurations, and that various changes, additions and modifications can be effected therein by one skilled in the art without departing from the scope of the invention as defined by the appended claims. For example, various combinations of the features of the dependent claims could be made with the features of the independent claims without departing from the scope of the present invention.

Some configurations of the present techniques are described by the following numbered clauses:
Clause 1. An apparatus comprising:
   processing circuitry configured to issue a memory access request specifying a target address; and
   memory access control circuitry configured to control handling of the memory access request based on at least one memory access control attribute associated with a corresponding region of address space including the target address, the memory access control circuitry comprising attribute storage circuitry configured to store a plurality of entries, each of the plurality of entries identifying a corresponding region of address space and information indicating at least one corresponding memory access control attribute for the corresponding region of address space,
   wherein:
   the memory access control circuitry is responsive to receipt of the memory access request to perform an attribute lookup in the attribute storage circuitry for the target address to identify the at least one memory access control attribute associated with the corresponding region of address space comprising the target address;
   the processing circuitry comprises current region identifying information indicative of a current region of address space and at least one current memory access control attribute associated with the current region of address space; and
   the processing circuitry is configured to determine whether the target address is comprised in the current region of address space and, when the target address is comprised in the current region of address space, to indicate the at least one current memory access control attribute to the memory access control circuitry, and to trigger the memory access control circuitry to omit performing the attribute lookup.
Clause 2. The apparatus of clause 1, wherein the attribute storage circuitry configured to support at least two regions of address space being of different sizes.
Clause 3. The apparatus of clause 1 or clause 2, wherein the memory access control circuitry is responsive to the lookup identifying an entry of the plurality of entries to return information indicative of the corresponding region of address space to the processing circuitry to trigger the processing circuitry to update the current region identifying information based on the corresponding region of address space.
Clause 4. The apparatus of clause 3, wherein the memory access control circuitry is responsive to the lookup identifying the entry of the plurality of entries to mark the entry in the attribute storage circuitry as invalid.
Clause 5. The apparatus of any preceding clause, wherein:
   the current region of address space is bounded by a first limit address and a second limit address; and
   the processing circuitry is configured to identify at least one of the first limit address and the second limit address as the current region identifying information.
Clause 6. The apparatus of clause 5, wherein the processing circuitry is configured to discard the other of the first limit address and the second limit address.
Clause 7. The apparatus of any preceding clause, wherein the processing circuitry comprises control circuitry configured to identify when the target address will fall outside of the current region of address space based on an observed sequence of memory accesses.
Clause 8. The apparatus of clause 7, wherein
   the control circuitry is configured to identify a pattern of target addresses in the observed sequence of memory addresses; and
   the control circuitry is configured to calculate a number of remaining requests, identifying target addresses within the current region, that can be issued according to the pattern of target addresses and to trigger the memory access control circuitry to omit performing the attribute lookup until the number of remaining requests in the pattern of target addresses have been issued.
Clause 9. The apparatus of clause 8, wherein the control circuitry is responsive to identification that the target address that does not fit the pattern, to trigger the memory access control circuitry to perform the attribute lookup.
Clause 10. The apparatus of any of clauses 8 to 9, wherein:
   the observed sequence of memory accesses is a sequence of instruction fetch requests, each of the sequence of instruction fetch requests identifying a block of instructions; and
   the processing circuitry is responsive to a branch instruction identifying a target block of instructions, to calculate whether the target block of instructions falls within the current region and, when the target block of instructions does not fall within the current region, to trigger the memory access control circuitry to perform the attribute lookup.
Clause 11. The apparatus of any preceding clause, wherein:
   the attribute storage circuitry is partitioned into an instruction attribute partition comprising a plurality of instruction entries and a data attribute partition comprising a plurality of data entries; and
   the memory access control circuitry is configured:
      to identify whether the memory access request is an instruction fetch request or a data fetch request;
      when the memory access request is the instruction fetch request, to perform the lookup in the instruction attribute partition; and
      when the memory access request is the data fetch request, to perform the lookup in the data attribute partition.
Clause 12. The apparatus of clause 11, wherein the instruction attribute partition comprises a different number of entries to the data attribute partition.
Clause 13. The apparatus of clause 11 or clause 12, wherein the memory access circuitry is responsive to one of the instruction entries being identified in the current region identifying information, to reassign that one of the instruction entries to the data attribute partition.
Clause 14. The apparatus of clauses 11 to 13, wherein the instruction attribute partition comprises fewer entries than the data attribute partition.
Clause 15. The apparatus of any preceding clause, wherein the current region identifying information comprises current data region identifying information and current instruction region identifying information.
Clause 16. The apparatus of any preceding clause, wherein the processing circuitry is responsive to an invalidation trigger indicating an invalidity of the current region of address space, to mark the current region of address space as invalid and to trigger the memory access control circuitry to perform the attribute lookup in response to a sequentially next memory access request.
Clause 17. The apparatus of any preceding clause, wherein the processing circuitry is configured to determine whether the target address is comprised in the current region of address space by performing at least one comparison of the target address against a limit address defining an extremum of the current region of address space.
Clause 18. A system comprising:
   the apparatus of any preceding clause, implemented in at least one packaged chip;
   at least one system component; and
   a board,
   wherein the at least one packaged chip and the at least one system component are assembled on the board.
Clause 19. A chip-containing product comprising the system of clause 18, wherein the system is assembled on a further board with at least one other product component.
Clause 20. A method of operating an apparatus comprising processing circuitry and memory access control circuitry, the method comprising:
   issuing, by the processing circuitry, a memory access request specifying a target address;
   controlling handling of the memory access request based on at least one memory access control attribute associated with a corresponding region of address space including the target address;
   storing, in attribute storage circuitry comprised in the memory access control circuitry, a plurality of entries, each of the plurality of entries identifying a corresponding region of address space and information indicating at least one corresponding memory access control attribute for the corresponding region of address space;
   in response to receipt, by the memory access control circuitry, of the memory access request to perform an attribute lookup in the attribute storage circuitry for the target address to identify the at least one memory access control attribute associated with the corresponding region of address space comprising the target address,
   wherein the processing circuitry comprises current region identifying information indicative of a current region of address space and at least one current memory access control attribute associated with the current region of address space; and
   determining, by the processing circuitry, whether the target address is comprised in the current region of address space and, when the target address is comprised in the current region of address space, indicating the at least one current memory access control attribute to the memory access control circuitry, and triggering the memory access control circuitry to omit performing the attribute lookup.
Clause 21. A non-transitory computer-readable medium storing computer-readable code for fabrication of the apparatus of any of clauses 1 to 17.

1. An apparatus comprising:
processing circuitry configured to issue a memory access request specifying a target address; and
memory access control circuitry configured to control handling of the memory access request based on at least one memory access control attribute associated with a corresponding region of address space including the target address, the memory access control circuitry comprising attribute storage circuitry configured to store a plurality of entries, each of the plurality of entries identifying a corresponding region of address space and information indicating at least one corresponding memory access control attribute for the corresponding region of address space,
wherein:
the memory access control circuitry is responsive to receipt of the memory access request to perform an attribute lookup in the attribute storage circuitry for the target address to identify the at least one memory access control attribute associated with the corresponding region of address space comprising the target address;
the processing circuitry comprises current region identifying information indicative of a current region of address space and at least one current memory access control attribute associated with the current region of address space;
the processing circuitry is configured to determine whether the target address is comprised in the current region of address space and, when the target address is comprised in the current region of address space, to indicate the at least one current memory access control attribute to the memory access control circuitry, and to trigger the memory access control circuitry to omit performing the attribute lookup; and
the current region identifying information is suitable for storing information indicative of a current region of address space having a size greater than a smallest addressable unit of the address space.

2. The apparatus of claim 1, wherein the attribute storage circuitry configured to support at least two regions of address space being of different sizes.

3. The apparatus of claim 1, wherein the memory access control circuitry is responsive to the attribute lookup identifying an entry of the plurality of entries to return information indicative of the corresponding region of address space to the processing circuitry to trigger the processing circuitry to update the current region identifying information based on the corresponding region of address space.

4. The apparatus of claim 3, wherein the memory access control circuitry is responsive to the attribute lookup identifying the entry of the plurality of entries to mark the entry in the attribute storage circuitry as invalid.

5. The apparatus of claim 1, wherein:
the current region of address space is bounded by a first limit address and a second limit address; and
the processing circuitry is configured to identify at least one of the first limit address and the second limit address as the current region identifying information.

6. The apparatus of claim 5, wherein the processing circuitry is configured to discard the other of the first limit address and the second limit address.

7. The apparatus of claim 1, wherein the processing circuitry comprises control circuitry configured to identify when the target address will fall outside of the current region of address space based on an observed sequence of memory accesses.

8. The apparatus of claim 7, wherein
the control circuitry is configured to identify a pattern of target addresses in the observed sequence of memory addresses; and
the control circuitry is configured to calculate a number of remaining requests, identifying target addresses within the current region, that can be issued according to the pattern of target addresses and to trigger the memory access control circuitry to omit performing the attribute lookup until the number of remaining requests in the pattern of target addresses have been issued.

9. The apparatus of claim 8, wherein the control circuitry is responsive to identification that the target address that does not fit the pattern, to trigger the memory access control circuitry to perform the attribute lookup.

10. The apparatus of claim 8, wherein:
the observed sequence of memory accesses is a sequence of instruction fetch requests, each of the sequence of instruction fetch requests identifying a block of instructions; and
the processing circuitry is responsive to a branch instruction identifying a target block of instructions, to calculate whether the target block of instructions falls within the current region and, when the target block of instructions does not fall within the current region, to trigger the memory access control circuitry to perform the attribute lookup.

11. The apparatus of claim 1, wherein:
the attribute storage circuitry is partitioned into an instruction attribute partition comprising a plurality of instruction entries and a data attribute partition comprising a plurality of data entries; and
the memory access control circuitry is configured:
to identify whether the memory access request is an instruction fetch request or a data fetch request;
when the memory access request is the instruction fetch request, to perform the lookup in the instruction attribute partition; and
when the memory access request is the data fetch request, to perform the lookup in the data attribute partition.

12. The apparatus of claim 11, wherein the instruction attribute partition comprises a different number of entries to the data attribute partition.

13. The apparatus of claim 11, wherein the memory access circuitry is responsive to one of the instruction entries being identified in the current region identifying information, to reassign that one of the instruction entries to the data attribute partition.

14. The apparatus of claim 1, wherein the current region identifying information comprises current data region identifying information and current instruction region identifying information.

15. The apparatus of claim 1, wherein the processing circuitry is responsive to an invalidation trigger indicating an invalidity of the current region of address space, to mark the current region of address space as invalid and to trigger the memory access control circuitry to perform the attribute lookup in response to a sequentially next memory access request.

16. The apparatus of claim 1, wherein the processing circuitry is configured to determine whether the target address is comprised in the current region of address space by performing at least one comparison of the target address against a limit address defining an extremum of the current region of address space.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method of operating an apparatus comprising processing circuitry and memory access control circuitry, the method comprising:
issuing, by the processing circuitry, a memory access request specifying a target address;
controlling handling of the memory access request based on at least one memory access control attribute associated with a corresponding region of address space including the target address;
storing, in attribute storage circuitry comprised in the memory access control circuitry, a plurality of entries, each of the plurality of entries identifying a corresponding region of address space and information indicating at least one corresponding memory access control attribute for the corresponding region of address space;
in response to receipt, by the memory access control circuitry, of the memory access request to perform an attribute lookup in the attribute storage circuitry for the target address to identify the at least one memory access control attribute associated with the corresponding region of address space comprising the target address,
wherein the processing circuitry comprises current region identifying information indicative of a current region of address space and at least one current memory access control attribute associated with the current region of address space; and
determining, by the processing circuitry, whether the target address is comprised in the current region of address space and, when the target address is comprised in the current region of address space, indicating the at least one current memory access control attribute to the memory access control circuitry, and triggering the memory access control circuitry to omit performing the attribute lookup,
wherein the current region identifying information is suitable for storing information indicative of a current region of address space having a size greater than a smallest addressable unit of the address space.

20. A non-transitory computer-readable medium storing computer-readable code for fabrication of an apparatus comprising:
processing circuitry configured to issue a memory access request specifying a target address; and
memory access control circuitry configured to control handling of the memory access request based on at least one memory access control attribute associated with a corresponding region of address space including the target address, the memory access control circuitry comprising attribute storage circuitry configured to store a plurality of entries, each of the plurality of entries identifying a corresponding region of address space and information indicating at least one corresponding memory access control attribute for the corresponding region of address space,
wherein:
the memory access control circuitry is responsive to receipt of the memory access request to perform an attribute lookup in the attribute storage circuitry for the target address to identify the at least one memory access control attribute associated with the corresponding region of address space comprising the target address;
the processing circuitry comprises current region identifying information indicative of a current region of address space and at least one current memory access control attribute associated with the current region of address space;
the processing circuitry is configured to determine whether the target address is comprised in the current region of address space and, when the target address is comprised in the current region of address space, to indicate the at least one current memory access control attribute to the memory access control circuitry, and to trigger the memory access control circuitry to omit performing the attribute lookup; and
the current region identifying information is suitable for storing information indicative of a current region of address space having a size greater than a smallest addressable unit of the address space.
